(19) United States
(12) Patent Application Publication
(10) Pub. No.: US 2010/0032954 A1
(43) Pub. Date: Feb. 11, 2010

(54) WIND TURBINE

(76) Inventor: Jonathan Andrew Law, London (GB)

Correspondence Address: William H Bollman;MANELLI DENISON & SELTER, Seventh Floor, 200 M Street NW, Washington, DC, 20036, US

(21) Appl. No.: 12/083,677

(22) PCT Filed: Oct. 18, 2006
(86) PCT No.: PCT/GB2006/003849

§ 371 Date: Oct. 1, 2009

(30) Foreign Application Priority Data
Oct. 18, 2005 (GB) 0521129.7

(51) Int. Cl. F03D 9/00; F03D 11/00

(52) U.S. Cl. 290/55; 290/52

(57) ABSTRACT

A wind turbine is described comprising two counter-rotating rotors, each rotor comprising an axle (5) carrying a series of blades (1). The rotors are mounted between two opposing aerofoils (2). The aerofoils (2) and the rotors together being mounted on a turntable (3). The turntable (3) is in turn mounted on a static housing (4) that contains gearing (6) and drive (8) mechanisms that are driven by the action of wind on the rotors and further drive a generator that generates electrical power.

### BACKGROUND OF THE INVENTION

The present invention relates to wind turbines. More particularly, but not exclusively, the invention relates to small-scale wind turbines that convert wind energy to electrical energy through the use of rotating turbines linked to a generator, for example of the type that may be located on a building for small scale or domestic generation of electricity.

Wind turbines for converting wind energy to electrical power are known. Conventional wind turbines can be viewed in many locations and in a variety of geographic sites. Generally such wind turbines tend to be large in scale and of a ‘windmill’ configuration, comprising a series of rotors erected on a mast and are often arranged in groups known as ‘wind farms’.

Such ‘wind farms’ are often considered to be unsightly and expensive to build and rely on their extreme scale and remote location in order successfully to generate electricity thereby competing with fossil fuel power stations or nuclear power stations.

Energy derived from wind energy is in proportion to the area of a ‘collector’ equivalent to the square of the radius of a traditional horizontal axis propeller.

Therefore a rotor of 10 m diameter typically captures four times as much energy as a rotor of 5 m in diameter. Therefore, maximising collector area is advantageous. Energy derived from wind energy is also proportional to the cube of the velocity of the wind. This occurs as a result of the momentum (mv) in a volume of air which has kinetic energy (½mv²) that is proportional to the square of the velocity of the volume of air.

Smaller domestic versions of wind turbines, for providing electrical power to residential or domestic situations, are available, but are still usually in excess of 2.4 m in diameter. These windmills or wind turbines are often too large and unsuitable for use in a populated environment as they are considered to be dangerous; because a large object moving at speed on top of a mast (for example in a garden of a small property) being potentially hazardous.

Furthermore, the rotor configuration described above requires highly engineered rotor blades, which increase the cost involved and such windmills are complex and expensive to install.

Moreover, in turbines of a windmill configuration it is difficult to transmit energy from a rotating generator, especially one mounted at high level.

A solution to the aforementioned problems has been to produce a relatively small wind turbine that is both lightweight and compact and was typically adapted to be fitted on the side of a house, on the roof of a house or on the chimney of a house.

### PRIOR ART

UK Patent Application GB-A-2 296 048 describes a further form of vertical axis wind turbine, in which a series of aerofoil-shaped blades are mounted on a single rotor, the aerofoils being rotatable to align with the wind direction experienced by the turbine. The blades are shielded and hence this wind turbine is safer than a ‘windmill’ configuration device.

However, a disadvantage of this form of vertical wind turbine is that its performance is related to the wind speed as found. That is to say the performance is only as good as the wind available.

Power derived from wind energy is proportional to the cube of wind speed. For example, a wind speed of twenty knots carries 8 times as much energy as a wind of 10 knots. Accordingly, increasing the ‘effective’ wind speed at the point of interaction with the turbines is advantageous.

An example of a small, lightweight and compact domestic wind turbine is disclosed in U.S. Pat. No. 4,074,951 (Hudson). U.S. Pat. No. 4,074,951 describes a wind power converter which has a pair of rotating turbines disposed in a generally horizontal configuration.

Another example of a wind turbine is described in International Patent Application WO-A1-03091569 (ADDIX). The wind turbine described has two or more vertical rotors arranged such that the rotors are housed in a housing which has a lateral air inlet.

A further example of a lightweight and compact domestic wind turbine is disclosed in U.S. Pat. No. 5,969,430 (FORREY). The wind turbine described utilises pressure differentials that occur between static pressure head and dynamic pressure heads. The turbine comprises a plurality of rotors mounted on parallel axes with vanes attached thereto, whereby certain vanes rotate and define a frontal resistance to oncoming airflow.

Although the aforementioned small and lightweight wind turbines have been successfully deployed in a number of domestic or industrial situations, they have not been as efficient as electrical generators.

German Offenlegungschrift DE-A1-103 22 919 (PETERS) discloses a wind turbine with twin rotors whose axes of rotation are parallel. Wind impinges the rotors through an inlet channel and the rotors are arranged to counter rotate.

An aim of the present invention is therefore to provide a wind turbine, which has improved electrical generation efficiency.

The invention aims to overcome other problems of known wind turbines whilst incorporating features enabling the wind turbine to experience increased effective wind speeds thereby improving efficiency of generation of electricity from a moving airflow.

### SUMMARY OF THE INVENTION

According to a first aspect of the invention, there is provided a wind turbine for converting wind energy to electrical energy comprising: a rotatable base having mounted thereon at least two vertical axis rotors, said rotors being provided with a series of blades enabling independent rotation of the rotors with respect to the base, characterised in that the rotors are supported between two opposed aerofoils, said aerofoils acting to increase the velocity of wind that impinges on the blades.

Ideally the aerofoils also assist in the rotation of the base in response to changes in wind direction, thereby orienting the turbine to the direction of the wind.

Preferably said aerofoils prevent wind impinging on the rotor blades on the return phase of the cycle and thereby further increasing the effective wind speed experienced by the rotor blades. The rotors achieve this by being shaped and dimensioned so as to effectively scoop air out of the leeward side or exhaust side of the housing.

Ideally the rotors are vertically mounted between the aerofoils and ideally the aerofoils are shaped so as to create a decrease in air pressure thereby maximising the velocity of the wind between the aerofoils. As the aerofoils are mirror images of one another, the effective lift force, which is generated by one aerofoil (and would act to turn the housing) is cancelled by the exact opposite force generated by a second aerofoil.

Advantageously the rotors are supported in a simple, bow-like or parallel-piped frame. This is cheap and easy to fabricate, replace and repair.

In this manner, fast moving parts of the wind turbine, namely the rotor blades, gears, torque converters and dynamo are encased and are not likely to pose a safety hazard. Likewise such moving parts are protected from weather and water ingress.

A governor may be fitted to the turbine and is ideally adapted to reduce the rotational velocity of the rotors as the speed of the wind increases. This acts as a braking mechanism in very strong winds thereby reducing the risk of damage to the turbine.

In an alternative embodiment the governor may be arranged to reduce the opening of an inlet to the housing: that is the aperture through which air enters the rotor housing. This may be achieved by a throttle type arrangement, which narrows the aperture by way of one or preferably a pair of wind vanes.

Ideally the rotor blades are helical and the rotors are mounted in a pair comprising left and right-handed helices. An advantage of this configuration is that there is less vibration; therefore the generator is more efficient and quieter. Additionally each blade is ideally curved in section to generate lift across the blade and further enhance the rotor speed.

Ideally the rotors are driven by movement of wind across the blades, whereby rotors drive a gearing mechanism, said gearing mechanism in turn drives a generator such that wind energy is converted into electrical energy.

Preferably the rotors are formed from shaped metal sheets or a synthetic moulded plastics material. Thus there is disclosed a wind turbine in which the component parts are formed from metal or plastics or composites and which are readily interchangeable for replacement in the event of damage or maintenance.

In a particularly preferred embodiment, the turbine in which the generator is housed is mounted in a static arrangement with respect to the wind turbine, whereby the turbine may alter its orientation with respect to wind direction.

A clutch may be operative to couple torque from the rotors to the generator so as to act as a governor in order to limit speed of rotation or to couple the rotor to a second gear train in the event of very high wind speed.

Preferred embodiments of the invention will now be described, by way of example only, and with reference to the accompanying drawings in which:

### BRIEF DESCRIPTION OF THE DRAWINGS

FIG. 1 shows an axonometric view of a preferred embodiment of wind turbine in accordance with the invention, showing an opposed-pair of aerofoils mounted on a rotatable base, the aerofoils partially enclosing a pair of rotors, the entire structure being mounted on an existing structure such as a roof of a house;

FIG. 2a is a plan of the wind turbine of FIG. 1 from above the base;

FIG. 2b is a sectional view showing hidden detail of the aerofoils and rotors;

FIG. 3a is an above plan view of the structure of the rotatable wind turbine of Figure;

FIG. 3b is a longitudinal sectional view, through the base and shows the structure of the rotatable wind turbine of FIG. 1;

FIG. 4a shows a plan view, at capping, of an alternative embodiment of the wind turbine, with mechanical governors;

FIG. 4b shows an above plan view of an alternative embodiment of the wind turbine, with mechanical governors;

FIG. 4c shows an under-plan view of an alternative embodiment of the wind turbine, with mechanical governors;

FIG. 5a shows a front elevation of the wind turbine of FIG. 4;

FIG. 5b shows a cross section of the wind turbine of FIG. 4;

FIG. 6a shows a diagrammatical view of a land-based array of turbines; and

FIG. 6b shows a diagrammatical view of an array of turbines mounted on a floating pontoon or island, for use at sea or in estuaries.

### DETAILED DESCRIPTION OF PREFERRED EMBODIMENTS OF THE INVENTION

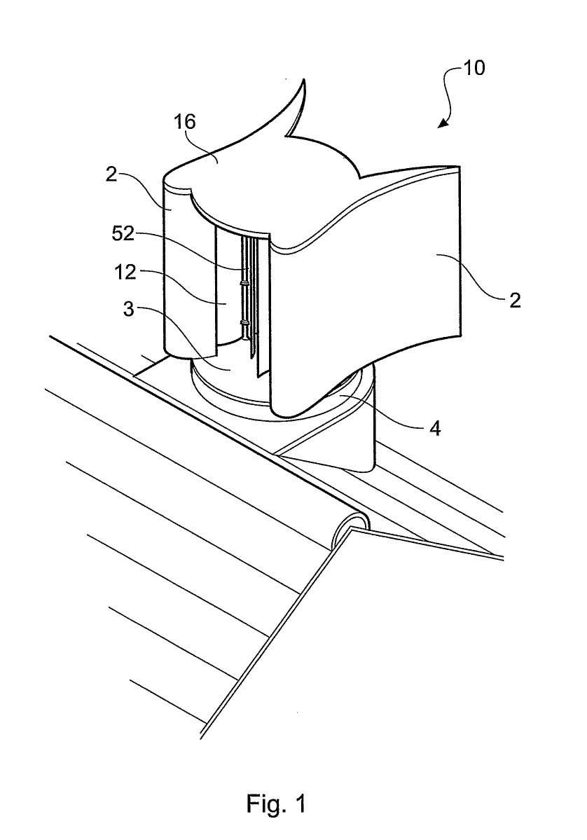

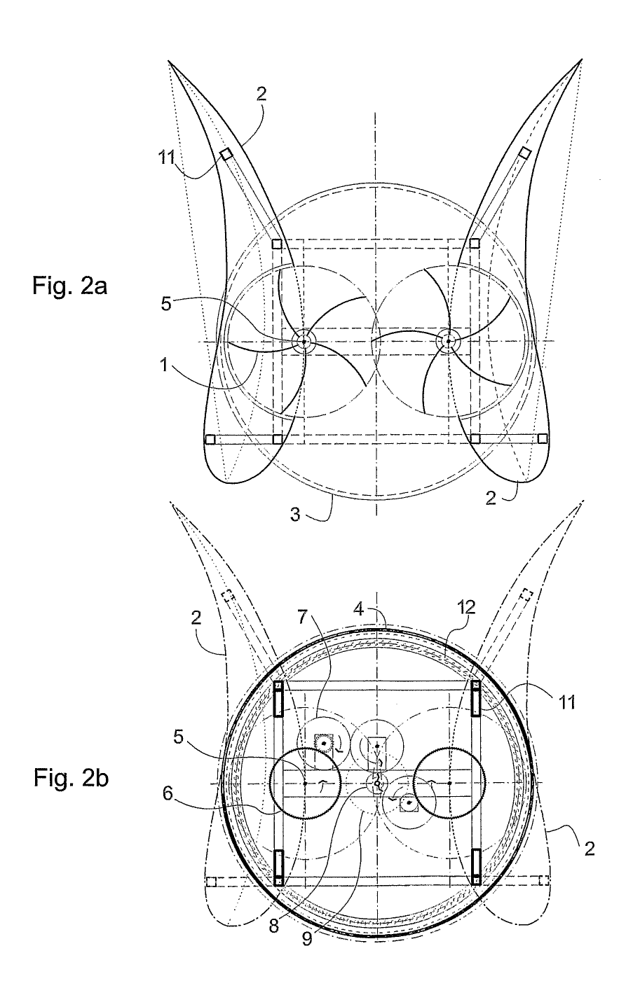

As shown in FIGS. 1 2a and 2b, the wind turbine 10, depicted as being mounted on the roof of a house, comprises a pair of substantially vertical-axis, paddle-type rotors 1a and 1b, each fitted with at least two curved blades 1 and semi-housed within two opposed aerofoils 2. The blades 1 of each rotor are slightly interlocking and counter-turning in directions of arrows A and B.

The rotors 1a and 1b further comprise axle rods 5a and 5b that extend below a turntable 3 and mesh with a gear wheels 6a and 6b. Gears 6 in turn mesh with a gearing mechanism 6. The aerofoils 2 are mounted in opposition on a freely rotating turntable 3. The turntable 3 is mounted, via a ring bearing 12, onto a static support 4. The static support 4 is secured to a suitably prepared existing structure, upon which the wind turbine 10 is to be sited.

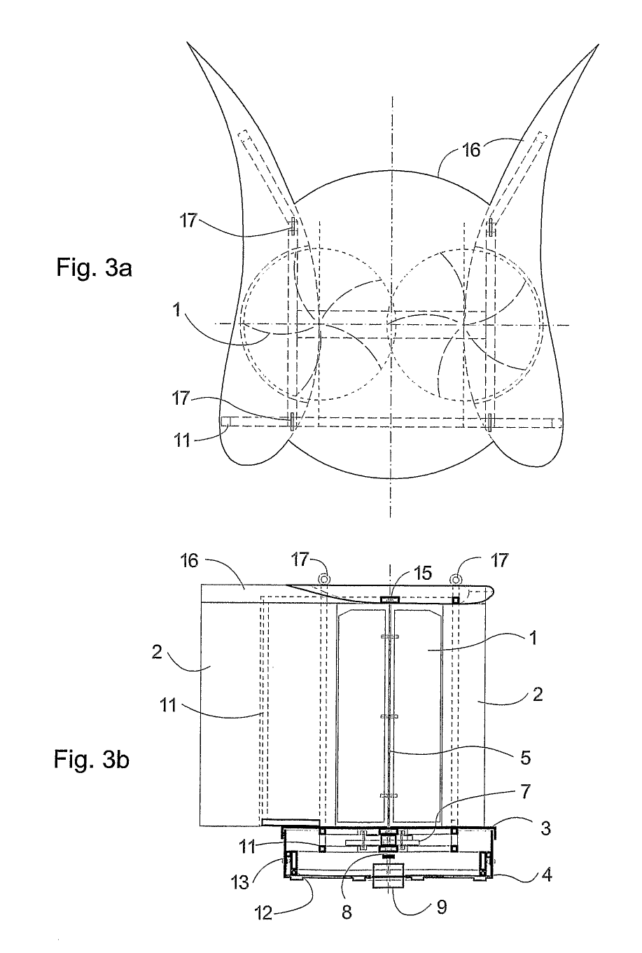

As shown in FIG. 3, the turntable 3 and the static support 4 form a housing for the gearing mechanism 6. The axle rods 5a and 5b turn a system of secondary gears 7 which transmit torque to a single final drive 8, centrally mounted within the turntable 3. A generator 9 is connected to the underside of the static support 4 or below the base, where space is available. The turbine axle rods 5, aerofoils 2, turntable 3, secondary gearing 7 and final drive 8 are all mounted onto a support frame 11.

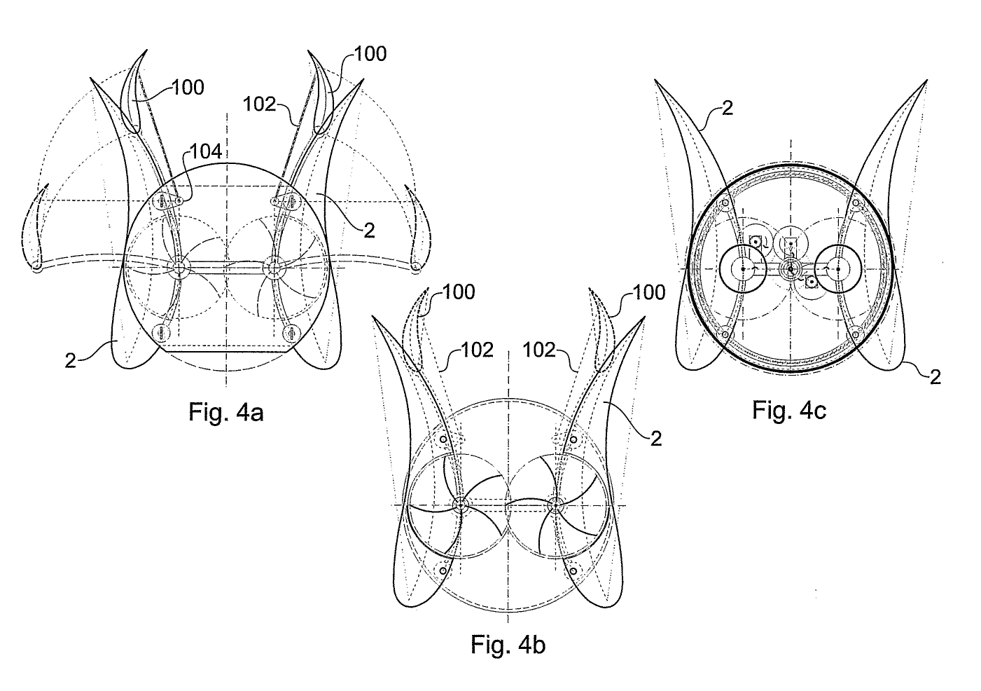

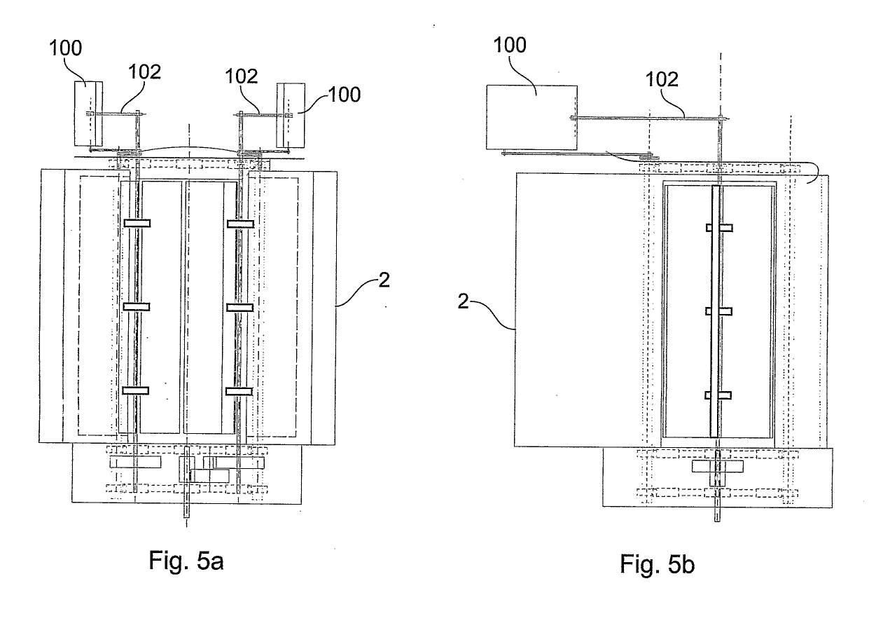

Referring to a second embodiment, as shown in FIGS. 4 and 5, in which like parts bear the same reference numerals, there is depicted a wind turbine 10 having a governor 100 fitted to each aerofoil. Governors 100 are linked to either a mechanical brake or a throttle by way of solid rods 102 connected to cams 104. In the event of very high winds, the governors 100 act in an opposite sense to the main aerofoils (as they are inverted with respect to the main aerofoils) and thereby slow the rotors to a safe angular velocity.

As shown in FIG. 5, the base of the frame 11 takes the form of a ring beam which bears onto a rotating ring bearing, 12 set onto the floor of the static support 4. Locking flanges 13 serve to prevent the turntable from lifting off the base.

The turbine axle rods are provided with top bearings 15 and the tops of the aerofoils are secured by the frame capping, 16 which may also incorporate lifting eyes 17 to allow easy installation of the unit when fully assembled.

In terms of materials, a preferred construction medium includes the use of metal or synthetic plastics to form the rotors and housing. However, it will be appreciated that glass-reinforced plastic, carbon-fibre, timber and canvas or a combination of these materials may be used.

When mounted on a suitable structure such as a roof of a building, the aerofoils 2 act so as to rotate the entire wind turbine and maintain an optimum position of the rotors with respect to the wind direction. The aerofoils 2 also provide a significantly increased wind speed over the rotor blades 1, when compared to the actual wind speed, the shape of the aerofoils 2 also preventing the wind reaching the rotor blades 1 on the return phase of their cycle.

The wind causes the rotor blades 1 to rotate on the axle rods 5 which in turn cause the gearing mechanism 6 and drive mechanism 8 to drive the generator (not shown) and hence produce electrical motive force (EMF).

The increase in wind speed between the aerofoils 2 creates a relative decrease in air pressure, giving rise to lift. This inward force on each aerofoil 2 is resisted by the opposite aerofoil, thus creating a stable system.

The invention allows the rotor blades 1 to be relatively encased and the structure compact, making it suitable for domestic and urban use. The preferred locations would be mounted on top of existing buildings or suitable tall structures.

The invention also allows the generator to be statically mounted at the base of the unit, simplifying the take off of electrical power.

It will be appreciated that the shape of the aerofoils 2 shown in the drawings is representative only and that any suitable form of aerofoil may be used.

It will further be appreciated that any number of blades 1 may be mounted on the axle rods 5 to form the rotors and that the shape of the blades 1 may be curved, as shown in the drawings, or any other suitable shape.

Again, the rotatable base 3 may take the form shown in the diagrams or any other suitable form may be adopted that is capable of performing the function described above.

The rotor blades 1 mounted on the axle rods 5 forming the two rotors are described as being partly interlocking but this need not be the case, the rotors could be positioned such that interlocking is not required.

In the manner described above, the invention overcomes all the problems of known wind turbines and provides an efficient wind turbine suitable for use in built-up or populated environments.

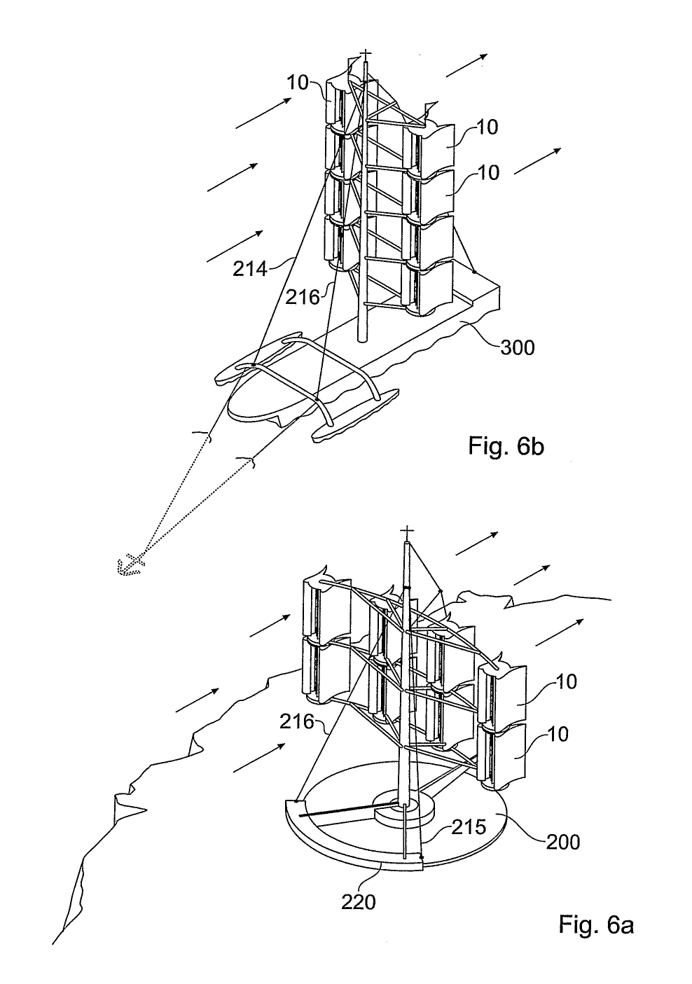

FIGS. 6a and 6b show respectively views of an array of turbines mounted on a tower fixed to a base 200 use on land and an array of turbines 10, mounted on a floating pontoon 300 or island, for use at sea or in estuaries. An array of turbines 10 is supported on a rotating gantry 220 or turntable 220 so as to permit the array to turn (or be turned) towards the direction of the wind. An anchor 350 or other tether is provided on the floating pontoon. Hawsers or tethers 214 and 216 are provided on the land based and the floating pontoon 300.

It will be appreciated that variation to the embodiments described may be made without departing from the scope of the invention. For example turbines may be arranged in a linear fashion (i.e. rows or stacks) or the turbines may be arranged in a 2-dimensional array or matrix.

1-16. (canceled)

17. A wind turbine for converting wind energy to electrical energy comprising a rotor with at least three blades mounted with its axis perpendicular to the wind, semi-housed along the low pressure face of an aerofoil, such that:
a) the aerofoil is oriented with positive angle of attack relative to the oncoming wind; with rounded leading edge, sharp trailing edge and with a positive camber thus providing a significant increase in the velocity of wind that passes across the blades of the rotor.
b) the segmental cut-out housing the rotor is sized closely to accommodate the sweep of the rotor blades, positioned in the widest part of the aerofoil towards the front of its section; shielding the return phase of the rotor's cycle.
c) the axis of the rotor is positioned such that the entire forward phase of the rotor's cycle is exposed to the oncoming wind, allowing the rotor blades to experience the direct force (thrust) of the oncoming wind, with some additional force (lift) generated due to the angle of the rotors relative to the wind as they emerge from and return towards the aerofoil.
d) the profile of the rotor blades is such as to partially reinstate the missing aerofoil surface at the cut-out, as the rotor revolves.

18. A wind turbine according to claim 17 wherein two aerofoil/rotor assemblages are mounted on a rotatable base enabling independent rotation of the rotors with respect to the base:
a) arranged as an opposed pair, symmetrical on the centre line of the axis of the base in the direction of the wind, and with both their high pressure faces facing each other, in which the rotors counter-rotate.
b) oriented with the gap between the aerofoils greater towards the rear than the front; (e.g. arranged with the tails curving away from each other)
c) positioned with their chords' mid-point located behind the centreline of the rotatable base to act as a vane and provide a means of self-orientation of the base into the wind.

19. A wind turbine according to claim 17 wherein the rotor blades are helical comprising left and right-handed helices, preventing the sweep of the rotor blade passing the edge of the housing at one time.

20. A wind turbine according to claim 17 wherein a shaped cover is provided over the aerofoil/rotor assembly to:
a) reduce the tendency of the horizontally drawn wind stream to break out vertically.
b) reduce turbulence around the upper frame cross member and axle rod top bearings.
c) introduce a further aerofoil-induced velocity enhancement to the wind passing through the turbine from the wind movement above the turbine.

21. A wind turbine according to claim 17 whereby, in use, the generator is statically mounted, with respect to the wind turbine, thereby providing a permanent support and straightforward conductive path for generated electricity, without the need for brushes and slip rings.

22. A wind turbine according to claim 17 further including a gearing mechanism for transmitting torque from the rotors to a generator.

23. A wind turbine according to claim 17 wherein a clutch is operative to couple torque from the, or each, rotor to the generator.

24. A wind turbine according to claim 17 wherein means is provided to operate as a governor, in conjunction with the clutch, in order to limit speed of rotation of the rotors, comprising:
a) protective doors, shields, flaps or covers capable of progressively disrupting the aerofoils' profiles and shielding the rotors from winds at higher velocities.
b) minor aerofoils, mounted away from the main body of the wind turbine, linked to the protective doors and designed progressively to operate the doors in response to the lift generated on the minor aerofoils in higher wind speeds.
c) counter-sprung links between the shields and the minor aerofoils such that, in the event of the failure of the mechanism, the doors will close, shielding the rotors.

25. A wind turbine according to claim 17 wherein component parts are formed from the group comprising: metal, synthetic plastics and composites.

26. A wind turbine for generating electrical energy from wind comprising a rotor with substantially vertical axle carrying a series of blades, the axles being semi-housed within the low pressure face of an aerodynamic aerofoil structure such that the effective wind speed passing over the aerofoil face experienced by the rotor is greater than the actual wind speed.

27. An assemblage or array of wind turbines according to claim 26 wherein the array is land-based, building-mounted, supported on a floating barge or vessel, or as a tethered buoyant structure.
